(19) United States
(12) Patent Application Publication
(10) Pub. No.: US 2014/0348614 A1
(43) Pub. Date: Nov. 27, 2014

(54) Article for Securing Multiple Materials

(71) Applicant: Martha Ann Martin, Charleston, SC (US)

(72) Inventor: Martha Ann Martin, Charleston, SC (US)

(21) Appl. No.: 14/120,237

(22) Filed: May 9, 2014

Related U.S. Application Data
(60) Provisional application No. 61/826,281, filed on May 22, 2013.

(51) Int. Cl. B43M 15/00

(52) U.S. Cl. CPC B43M 15/00
USPC 411/439

(57) ABSTRACT

Disclosed is a securing article combination including a pin with an oversized head (top) and a cap to fit snugly over the pin point (tip) after the pin has been used to join multiple layers of a material or multiple materials. The materials may be of cloth or fabric natures, as well as other items for which the securing device may be suitable for use. Alternatively, the pin head may be of a variety of decorative shapes to provide a decorative use in addition to its securing function. Such use is made possible due to the convenient use of a cap of a shape that conforms to the shape of the pin shaft and made of an elastomeric material, typically clear or opaque.

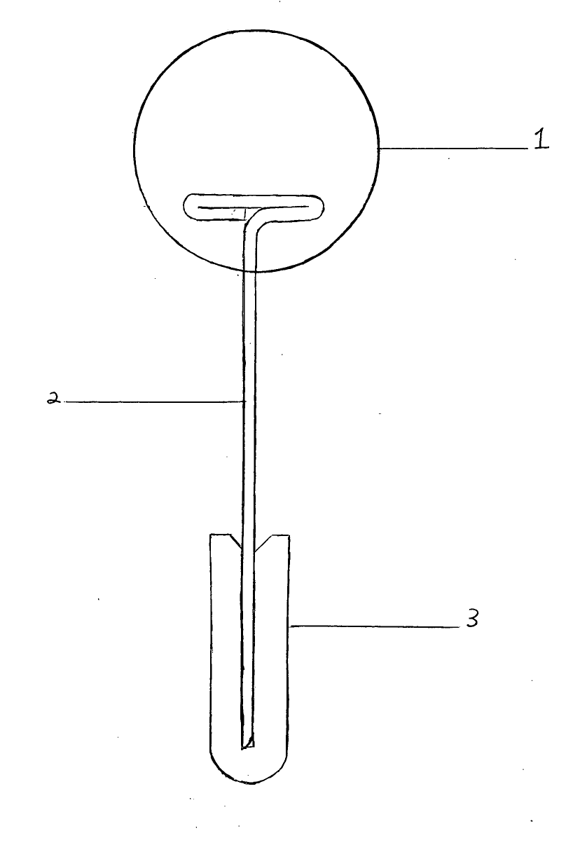

The invention disclosed herein claims the benefit of Provisional Application No. 61/826,281, filed May 22, 2013

### BACKGROUND

1. Field of the Invention

The disclosed article's securing mechanism has utility in various fields. Many arts and crafts serve to benefit from its use. The disclosed article includes a pin with an over-sized head (in relation to the pin body) and a securing portion that serves the function of safely securing the pin in place without unduly interfering with the material(s) secured thereby.

2. Description of the Prior Art

The closest prior art device in regard to function performed by the disclosed invention article is the common safety pin. Yet, the safety pin, while protecting one from its use by providing protection from contact with its pin point, the various manners of such protection often create a problem in its use, i.e., the lack of design and the need either for hiding the pin altogether or limiting its use to “temporary”; thus, requiring another method of a necessary securing function for any longer term.

Beyond the common safety pin, various articles are disclosed in the prior for providing a similar function.

U.S. Pat. No. 4,961,275 discloses separate an identification badge made with hook and loop fabric portions having a smaller metal piece with attachment pins directed toward the body of the wearer of the badge. The pin portions travel through one member of the hook and loop (either the hook member or the loop member) and through an article of clothing on the badge wearer to be held against the outside of said article of clothing by securing clamps located on the inside of said article of clothing, basically permitting attachment of the relatively soft fabric (hook or loop) badge in a manner to remove said outer fabric portion without disconnecting the metal piece and inner fabric portion from the wearer's article of clothing.

U.S. Pat. No. 5,170,542 discloses a jewelry clutch that includes a body portion having an open cavity formed therein and an elastomeric clutch element in the cavity for receiving and securing a post of a jewelry item in the clutch. The body has a substantially triangular cross sectional configuration to enable the clutch to be more easily grasped between the thumb and first two fingers of a hand of a user. The cavity passing through the body portion and the elastomeric clutch element continues out the end of the clutch itself wherein the sharp end of the jewelry post protrudes out of the end of the clutch, thus exposing its pin point.

U.S. Pat. No. 6,279,202 discloses a lapel pin that includes a display portion and a post portion moveably connected to the display portion. Preferably, the post portion is hingedly moveably disposed relative to the display portion and the display portion preferably includes a recessed portion for receiving the post portion when the lapel pin is not in use. When in use the post portion extends through the user's clothing and held in such position via a clasp mechanically by two opposing hinged releases.

U.S. Pat. No. 8,348,251 discloses a sewing clip for clamping fabrics of various thicknesses, sizes, elasticity, and textures in assistance of a sewing operation. The sewing clip includes two rigid members and an elastic assembly. This disclosure provides an alternate mechanism for the use of a pin altogether.

U.S. Pat. No. 8,052,017 discloses a moor, or anchor, for pins, needles, or other sewing implements. Said moor or anchor has a first end and second end, the first and second ends are connected by a central portion which may be curved, whereby the moor or anchor can be positioned on a surface and receive a pin, needle, or other sewing implement to anchor a piece of fabric to the surface. The surface may be fabric, cloth, vinyl, plastic or any other flexible material. The moor or anchor may be configured in various shapes and include curved portions and planar surfaces. A method of use of the moor or anchor is disclosed in the art of quilt making, where such use is in a temporary step in the making of the quilt and does not reside in the finished product.

The foregoing prior art disclosures provide pin securing devices that a either do not protect the user from a protrusion of the pin point or provide an awkwardly shaped, possibly over-sized clasp (or anchor) that must either only be temporary in use or remain unseen or hidden in any final implementation. The result being that the prior art pin may be used only temporarily during a sewing project; otherwise, the pin and its securing means disclosed in the prior art are to remain unseen altogether and provide function only, without any redeeming decorative value.

### BRIEF DESCRIPTION OF THE INVENTION

The disclosed invention securing article combination includes a pin with an oversized head (top) and a cap to fit snugly over the pin point (tip) after the pin has been used to join multiple layers of a material or multiple materials. The materials may be of cloth or fabric natures, as well as other items for which the securing device may be suitable for use. Alternatively, the pin head may be of a variety of decorative shapes to provide a decorative use in addition to its securing function. Such use is made possible due to the convenient use of a cap of a shape that conforms to the shape of the pin shaft and made of a clear or opaque elastomeric material.

### BRIEF DESCRIPTION OF THE DRAWING

The single FIGURE shows a cross-sectional perspective of the invention securing article combination of a pin with an oversized pin head (1), in relation to the size of the pin shaft (2), and a securing cap (3). The relatively large shaped pin head (1) size helps retain the pin shaft in place and provides an opportunity to decorate the material or article being pinned. The securing cap (3) is a combination of function and style in that it secures the pin in place without taking away from its decorative aspects, as described further below.

### DETAILED DESCRIPTION OF THE INVENTION

The disclosed invention securing article combination includes a pin with an oversized head (top) and an end cap to fit snugly over the pin point (tip) after the pin has been used to join multiple layers of a material or multiple materials. The materials may be of cloth or fabric natures, as well as other items for which the securing device may be suitable for use. Alternatively, the pin head may be of a variety of decorative shapes to provide a decorative use in addition to its securing function. Such use is made possible due to the convenient use of a cap of a shape that conforms to the shape of the pin shaft and made of a clear or opaque elastomeric material. The cap is elongated and includes a hollow middle portion to receive the point and a portion of the pin shaft.

The invention securing article combination is further disclosed with reference to the FIGURE, which shows the pin and cap combined, including a pin head (1), pin shaft (2) and removable cap (3). The pin head (1) is designed to be over-sized in relation to the pin shaft to insure permanent capture of the layers of material through which the pin may be placed, until intentionally withdrawn by the user. Desirably, the pin head may be decorative in nature, adding an artistic quality to the device. The pin head may consist of a variety of materials. It may take the shape of a large plastic ball, or a plastic material of any desired shape. While one of many decorative designs may be employed, it is preferred that any decoration take a shape that may be easily grasped and held to enable easy use. Though ease of attachment to the pin may be a factor in choice of materials, such materials as stone, metals, such as aluminum, silver, gold, steel, or even glass may be employed.

The pin shaft (2) is provided in sufficient length to allow multiple uses of the invention securing article combination, whether for securing together a greater multiple of layers of material(s) or to accommodate thicker layers of individual materials. The pin shaft (2) length must be sufficient to account for its attachment to the pin head (1). For example, the topmost portion of the pin shaft may be shaped in a manner to more easily accommodate attachment of the pin head (1) thereto. The lower portion of the pin shaft (2) must allow for an area above the end, or tip of the pin shaft (2) to allow sufficient area contact between the pin shaft (2) and the cap (3) to assure the cap remains in place until removed by the user.

Finally, the elongated cap (3) is provided with a hollow interior portion to accept the pin shaft portion terminating in the point of the pin shaft (2) to enclose the pin point for protection of the user from the potential of its stab. Thus, the hollow portion is open at the top of the cap to receive the pin shaft terminal portion and closed at the end to enclose the pin point within the cap's hollow portion. Additionally, the diameter of the hollow portion is engineered to be of a degree smaller than the diameter of the pin shaft adequate to insure that the tension between the metal pin shaft and the inner wall of the hollow portion of the cap is great enough to preclude removal of the cap from the pin shaft unless manually removed by the user.

The potential uses for the invention securing device are unlimited. In any instance where a common safety pin might be employed, the use of the invention securing device may be used without a concern of its exposure of the top end of the combination pin and cap. In an example of using a series of common safety pins to provide a temporary hem in an over-long window drapery, the invention securing combination pin and cap can accomplish the same hem without it being necessarily temporary, as the decorative pin head actually provides a series of decorative enhancements that could provide a long term solution. Such same distinction and decided advantage will appear an any use of the invention securing article, such as: a quick and attractive button replacement on an article of clothing; repairing/replacing a broken or missing shower curtain holder; making a fast and simple pillow cover by wrapping the pillow in a decorative fabric and securing said cover by use of multiple invention decorative securing articles in pinning the final exposed flap of fabric; in the cases where the decorative pin head is season-related a seasonal decoration may be used as the pin head, or alternatively the pin could be used to attach a seasonal decoration (e.g., deer for Christmas, bunny for Easter, etc.) onto standard household articles such as lampshades, curtains, etc. There are innumerable uses for the invention securing article, including many as yet not even thought of by those involved in providing arts and craft type decor enhancements in home decoration.

More particularly, the invention pin and cap securing combination for joining layers of an article of material wherein the pin comprises an opposing head and point separated by a shaft portion and the cap comprises a means for securing the pin to the article and encapsulates a lower portion of the pin terminating in a pin point. Also, the pin and cap securing combination of claim includes a pin head constructed of a decorative shape and the cap is elongated and includes a hollow middle portion to receive the point and a lower portion of the pin shaft. Further, the pin and cap securing combination includes head decorative shape selected from shapes including a ball and figurines of various shapes, and a cap constructed of an elastomeric material and shaped to fit snugly over the point. Finally, the pin and cap securing combination elastomeric cap is selected from the group of colors including clear and opaque. While the cap may take on any desired color, if clear or opaque it will more easily blend in with the color and/or pattern of the layers of material(s) being secured thereby.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A pin and cap securing combination for joining multiple layers of at least one of an article of material wherein the pin comprises an opposing head and point separated by a shaft portion and the cap comprises a means for securing the pin to the article and encapsulates a lower portion of the pin terminating in a pin point.

2. The pin and cap securing combination of claim 1 wherein the head is constructed of a decorative shape and the cap is elongated and includes a hollow middle portion to receive the point and a lower portion of the pin shaft.

3. The pin and cap securing combination of claim 2 wherein the head decorative shape is selected from shapes selected from the group of shapes including a ball and figurines of various shapes, and the cap is constructed of an elastomeric material and shaped to fit snugly over the point.

4. The pin and cap securing combination of claim 2 wherein the elastomeric cap is selected from the group of colors including clear and opaque.

5. The pin and cap securing combination of claim 1 wherein the material is selected from the group consisting of fabrics, cloths, vinyl, and plastic.

6. The pin and cap securing combination of claim 1 wherein the layers are of multiple thicknesses.
